(19) United States
(12) Patent Application Publication
(10) Pub. No.: US 2004/0078335 A1
(43) Pub. Date: Apr. 22, 2004

(54) Transportation security system and method that supports international travel

(76) Inventors: Raymond V. Calvesio, Apple Valley, MN (US); Michael J. Glavan, Edina, MN (US); Virgil V. Polinske, Afton, MN (US); John A. Olson, Eagan, MN (US); Shozo Kabeya, Gamagori-shi (JP)

Correspondence Address: Beth L. McMahon, Unisys Corporation, MS 4773, P.O. Box 64942, St. Paul, MN, 55164, US

(21) Appl. No.: 10/642,892

(22) Filed: Aug. 18, 2003

Related U.S. Application Data
(60) Provisional application No. 60/478,633, filed on Jun. 13, 2003.

(30) Foreign Application Priority Data
Aug. 29, 2002 (JP) 2002-251150

(51) Int. Cl. H04K 1/00

(52) U.S. Cl. 705/50

(57) ABSTRACT

A system and method that allows a traveler to enroll, then participate, in an automated process that completes the requirements to enable the traveler to cross an international border. In one embodiment, the automated process includes both an automated check-in process performed prior to travel departure, and a clearance process initiated after the border crossing. According to the preferred embodiment, both the check-in and clearance process verify the traveler's identity using biometric samples that are compared to samples collected during enrollment. During the automated process, the user may be prompted to supply immigration declarations and other questionnaires that are required by the destination country. According to another aspect, manual and/or automated checks may be initiated to review the information supplied on these questionnaires, and to further determine whether the traveler poses any potential risks to the destination country.

### CLAIM OF PRIORITY TO PARENT APPLICATION

This application claims priority to provisionally filed U.S. Patent Application serial No. 60/478,633 filed Jun. 13, 2003, attorney docket number RA-5621, which is incorporated herein by reference in its entirety.

### CROSS REFERENCE TO OTHER CO-PENDING Applications

U.S. patent application Ser. No. 10/418,888 filed Apr. 18, 2003, and entitled, “Remote Biometric Verification”, (Attorney Docket Number RA-5584); U.S. patent application Ser. No. 10/418,477 filed Apr. 18, 2003, and entitled, “Improved Seat Assignment System and Method for an Airline Reservation System”, (Attorney Docket Number RA-5585); U.S. patent application Ser. No. 10/418,892 filed Apr. 18, 2003, and entitled, “Use of Biometric Device Integrated Into Self-Service Kiosk”, (Attorney Docket Number RA-5572); U.S. patent application Ser. No. 10/418,933 filed Apr. 18, 2003, and entitled, “Self-Service Airline Check In System and Method That is Airline Independent”, (Attorney Docket Number RA-5586); and U.S. patent application Ser. No. 10/418,985 filed Apr. 18, 2003, and entitled “System and Method for Providing and Using Encoded Visual Identification Data within a Transportation Security System”, (Attorney Docket Number RA-5587), are commonly assigned co-pending applications incorporated herein by reference.

### FIELD OF THE INVENTION

The present invention generally relates to a check-in system and method for a transportation system; and, more particularly, relates to a system and method for processing passengers that are intending to cross international borders.

### BACKGROUND OF THE INVENTION

It is known in the prior art to engage in passenger check-in at airports. This has become a very expensive process for several major reasons. The first of these is the need for enhanced security in view of world events. As a result, the security resources, procedures, equipment, and personnel have continued to increase. This is likely to be a long-term problem rather than one that simply corresponds to the current mood of the populace.

A second concern is the increase of personnel costs associated with passenger check-in. To be sure, this includes security matters, but it also involves issuing tickets, boarding passes, baggage claim checks, etc. all within expanding passenger expectations of flexibility, service, speed, efficiency, etc. Thus, the central focus for both of these concerns is personnel cost.

In addition to expense, the increase of security measures has led to long lines. Travelers must arrive hours in advance of a flight to ensure that the check-in process will be completed prior to the time of departure. The inconvenience associated with this process, may, in some instances, cause airline customers to drive rather than fly to their destination whenever possible.

While check-in can be a time consuming and sometimes frustrating process for passengers that are flying intra-national routes, the problems are compounded where border crossings are involved. A passenger bound on an international flight must often endure long delays at both the points of departure and destination to complete immigration procedures. These procedures are intended to secure national borders against the influx of terrorists and terrorist weapons, drugs, and illegal contraband. Immigration agencies also attempt to protect national agricultural and economic interests against harmful pests and diseases, and safeguard business interests from theft of intellectual property. Other duties include the facilitation of international trade, collection of import duties, and the enforcement of trade laws.

Accomplishing the foregoing goals generally requires that immigration agents conduct one or more personal inspections and interviews with each passenger that is embarking on an international flight. During this manual process, the passenger's documentation, including a passport, visa, and/or other personal documentation will be inspected to verify that the passenger is indeed the person listed on the documents. The passenger's identity may be crosschecked against one or more lists of people that are not allowed to enter the country of destination because they are suspected of terrorist activities, or have been convicted of an unpardoned criminal offense, for example. Additionally, the passenger may be detained for random questioning or interrogation. This may include a search of the passenger's luggage.

Once the passenger has passed a immigration inspection at the point of departure, a boarding pass may be issued, allowing the passenger to board the plane for the flight. While the flight is underway, the passenger is generally required to complete immigration documentation that requires the passenger to declare the types of goods and currency being brought into the destination country.

Upon arriving at a destination, the passenger is generally again required to wait in a queue to be processed by yet another immigration official. This official may verify the passenger's documentation, including passport and other personal identification information. This information may be checked against various databases to ensure that the document holder is eligible for entry into the country. The immigration official will review the immigration questionnaires, and may question the passenger concerning any of the declarations. The passenger's luggage may be searched.

As can be appreciated by the foregoing discussion, international travel can be a frustrating and time consuming undertaking. For business travelers that must undergo the rigors of international travel on a regular basis, immigration procedures can become especially tedious. What is needed, therefore, is improved system and method for more efficiently processing passengers that are intending to cross international borders.

### SUMMARY OF THE INVENTION

The present invention overcomes the disadvantages of the prior art by providing a system and method that allows a traveler to enroll, then participate, in an automated process that completes the requirements to enable the traveler to cross an international border. According to the current invention, the traveler visits an enrollment center sometime prior to the time of travel. At this center, the traveler's identification is verified. This can be accomplished by manual means. For example, an enrollment representative may compare the user's appearance with a photograph that is included on a driver's license or passport. Additionally, this photograph is scanned and compared against an electronic image that is on file with a designated enrollment official. In one embodiment, a passport photograph may be scanned for comparison against an official passport photograph on file with the U.S. State Department. Other official documents issued by a state or organization that are used by the holder for international travel (also referred to as Official Travel Documents, or OTDs) may be employed for this purpose.

After the traveler's identity has been verified, unique identification indicia is collected from the user. In one embodiment, this involves collecting one or more biometric samples such as fingerprints, iris scans, facial scans including facial geometric readings, writing or voice samples, hand or any other physiological geometric measurements, or any other type of biometric data. Preferably, multiple different biometric samples are obtained to increase the accuracy of the identification. The collected data is stored with other user information such as a passport photo. This recorded enrollment data may be used at a time of travel to enable the user to undergo an automated immigration check-in and clearance process. Alternatively, the biometric data may be stored on a secure token such as a smart card. The secure token is provided to the traveler for use in identification verification during travel.

After the user has provided the enrollment data, various manual and/or automated checks are performed to analyze the risk posed by the traveler. For example, various database searches may be initiated to determine whether the traveler poses any known criminal, terrorist, health, or other security risk to the country of destination. If any problems are encountered with any of these checks, a rejection status code is generated and may be stored with the traveler's enrollment data, thereby disqualifying the traveler from using the automated check-in and clearance process at the time of travel. This status code may indicate the type of problem or situation that has been encountered during the automated and/or manual checks. Otherwise, an acceptance status code is generated and may be recorded with the enrollment data.

On the day of travel, the user approaches a user interaction device such as an automated self-service kiosk that may reside at a transportation facility such as an airport terminal. This kiosk is coupled via some communication mechanism to a system that stores the previously collected enrollment data. The user enters unique identification information such as a name, address, social security number, pin number, and/or some other unique identifier. Alternatively, or in addition, the user may be prompted to scan a passport or another OTD document. Information obtained in this manner is used to retrieve the enrollment data.

Next, the user is prompted to supply biometric data using one or more biometric devices coupled to the kiosk. The collected biometric data is compared to the retrieved enrollment data or data stored on a secure token to verify identity. If identity verification fails, the user is directed to a manual processing line to be processed by airline personnel. The user may also be directed to undergo manual processing as the result of a random selection procedure. However, if identity verification completes successfully and the user is not randomly selected for manual checks, the user is allowed to complete the automated check-in process.

During completion of the automated check-in process, the user may be queried to complete a immigration declaration form and/or one or more other questionnaires that are required by the destination country. These completed questionnaires may be stored with the traveler's enrollment data. Finally, travel documents such as the user's boarding pass and baggage tags may be printed to allow the traveler to board an airplane, bus, train, boat, or other form of transportation.

In one embodiment of the invention, while the traveler is enroute to the destination, automated and/or manual checks are performed on the data that was supplied by the traveler during the check-in process. This includes the data supplied on any immigration declaration form and/or other questionnaire(s) required by the destination country. This data is reviewed to determine whether the traveler has visited a country or location that is associated with a health risk, or whether the traveler is carrying goods into the destination country that would pose a health, agricultural, or other type of threat. In addition, various database searches may be initiated to determine whether the traveler's criminal or terrorist status has changed since the time of enrollment. If any problems are encountered with any of these checks, a rejection status code is generated and may be stored with the traveler's enrollment data. This rejection code, which will generally indicate the type of problem that has been encountered, will disqualify the traveler from using an automated clearance process at the point of destination. Otherwise, an acceptance status code is generated and may be recorded with the enrollment data.

Upon arrival at the destination, the traveler approaches a second user interaction device such as another self-service kiosk. The traveler supplies some form of identification to initiate the automated clearance process. For example, the traveler may scan travel documents such as a passport or another OTD. In addition or in the alternative, the user may supply unique identification data in the manner discussed above. This information is used to retrieve the stored enrollment data. The traveler is again prompted to supply biometric data so that the traveler's identity may be verified. If the retrieved status code indicates that a potential problem exists, the traveler is directed to the appropriate authority based on the stored rejection code. Otherwise, the user is allowed to retrieve all baggage and depart the immigration area via an exit gate, which may be controlled by an automated exit process.

The inventive system and method provides several advantages over prior art approaches. First, multiple processes are streamlined into a single expedited procedure. For example, according to the current invention, checks that are generally performed by immigration and immigration officials are incorporated with check-in procedures that are generally administrated by the transportation provider to create a unified processing method. This saves time for the traveler, and conserves the resources of the transportation provider. Second, assuming the traveler is eligible to participate in the automated procedure, most of the steps in the process are performed without human intervention. This further reduces costs incurred by the transportation industry, and may also reduce costs incurred by travelers, as well as law enforcement and other government agencies. Additionally, the invention provides a “threat-based” security system that allows threat analysis to be performed on travelers before the date of travel. Those travelers that are determined to be a minimal security, health, or other risk may by-pass the staffed checkpoints on the date of travel. Security and other transportation personnel are therefore able to spend more time processing travelers that are associated with an unknown degree of risk. This increases the overall level of security while reducing costs.

According to one aspect of the invention, a method for processing travelers crossing international borders is disclosed. The method includes enrolling a traveler to utilize an automated check-in process prior to the time of travel, and, at the time of travel, utilizing an automated check-in process to complete activities necessary to enable an international border crossing.

In another embodiment, a system for performing automated processing of a traveler crossing an international border is described. The system includes a data processing system to enroll a traveler to use an automated check-in procedure. The system further includes a first user interaction system coupled to the data processing system to provide the automated check-in procedure that automatically initiates activities necessary to allow the traveler to cross the international border. The system may further include a second user interaction system coupled to the data processing system to provide an automated clearance procedure that automatically initiates activities necessary to allow the traveler to enter a country of destination after the international border has been crossed.

According to still another aspect of the invention, a system for managing the crossing of an international border by a traveler is provided. The system includes enrollment means for enrolling the traveler in an automated travel process, and automated user interface means for allowing the user to participate in the automated travel process that completes all activities required for entry into a country without the need for human intervention. The automated user interface means may include first means for automatically performing check-in activities before crossing the border, and second means for automatically performing clearance activities after crossing the border.

Other scopes and aspects of the invention will become apparent from the following description and the accompanying drawings.

### BRIEF DESCRIPTION OF THE DRAWINGS

FIG. 1 is detailed block diagram illustrating one embodiment of a system that may employ the present invention.

FIG. 2 is a system block diagram illustrating one embodiment of an enrollment system according to the current invention.

FIG. 3 is a flow diagram of one embodiment of an enrollment process according to the current invention.

FIG. 4 is a flow diagram of one embodiment of a check-in process according to the current invention.

FIG. 5 is a flow diagram of one embodiment of a data collection process performed during, or after, the automated check-in process.

FIG. 6 is a flow diagram of one embodiment of a clearance process according to the current invention.

### DETAILED DESCRIPTION OF THE PREFERRED EMBODIMENT

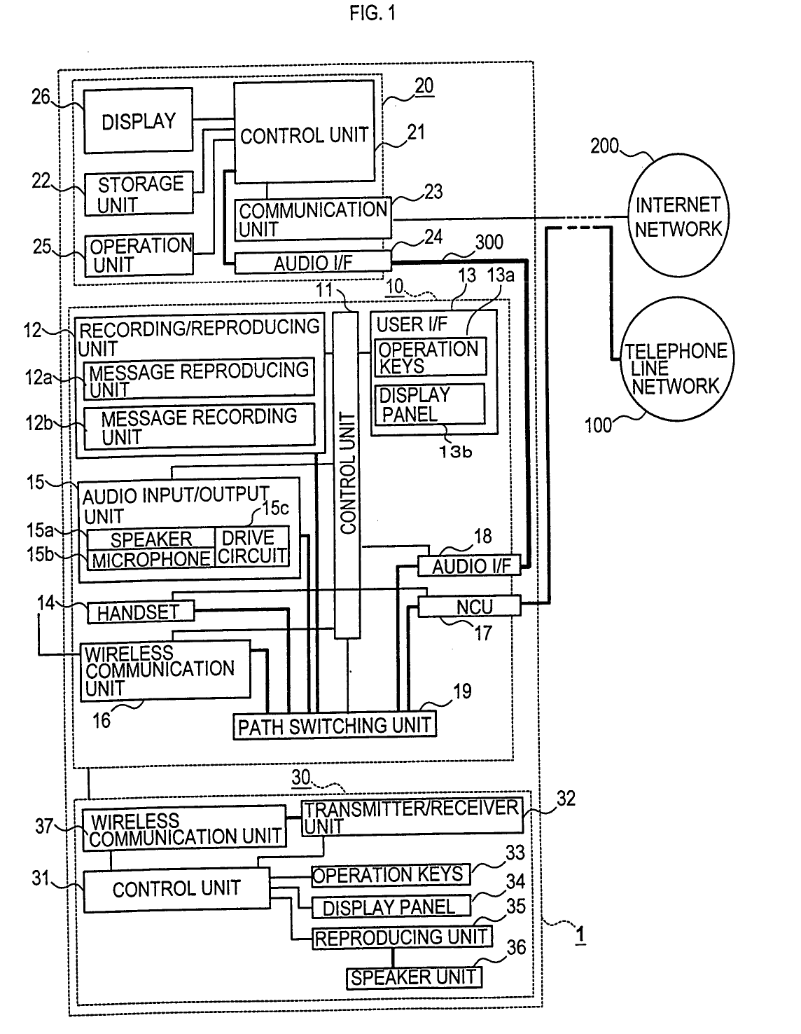

FIG. 1 is a detailed block diagram of one embodiment of a system that may use the current invention. This system includes a self-service kiosk 101 that is generally located somewhere within an airport, at a hotel or resort facility, a shopping mall, or at another public location conveniently accessible to users. The kiosk provides all functions needed to allow a user to perform check-in functions in preparation for an airline flight. The check-in activities may generally be completed without the need for human assistance. This will be discussed further below in reference to the invention.

Kiosk 101 includes user interface devices 112 that permit the traveler to directly interact with kiosk 101. These interface devices, which may include video and audio devices, touch screen capabilities, keypads, cursor manipulation devices, card readers, and any other interface devices, provide the user with the capability to supply input to, and receive output from, the kiosk. A typical kiosk includes at least a display screen and some type of user input device that allows for the entry of data and menu selections. These functions are discussed in more detail below.

User interface devices 112 are communicatively coupled to a kiosk check-in application 116, which is a software application that receives input from, and provides output to, users. Input received from a user may be routed to a kiosk server 114 for processing, or to one of the other devices to which it is coupled. Similarly, kiosk check-in application 116 may receive information from kiosk server 114 that is forwarded to the user via one of the user interface devices 112. Kiosk check-in application 116 provides the menus the passenger needs to perform his/her check-in activities.

Kiosk check-in application 116 is coupled to one or more biometric devices 132-138 via a biometric interface 122. Biometric devices 132-138 provide kiosk 101 with on-site biometric identification sensing. These biometric devices may include fingerprint readers, iris scanners, facial scanning devices, physical measurement devices such as devices that measure and quantify the unique geometry of a face, voice recognition devices, and/or any type of biometric devices.

As mentioned above, in one embodiment, the biometric devices are coupled to kiosk check-in application 116 via biometric interface 122. This interface, which could be an Application Program Interface (API) or another type of standardized or non-standardized interface, allows one or more biometric devices such as fingerprint, iris, facial, and other scanners to be added or removed from kiosk 101 without major system impact. Furthermore, modifications may be made to the biometric device(s) themselves without impacting the other components in the system such as the user interfaces. This permits modular upgrades to the kiosk as changes in technology and security requirements dictate. In one embodiment, biometric interface is a standardized Application Program Interface promulgated by the Biometric API consortium (www.bioapi.org).

In one embodiment of the invention, biometric interface 122 may be coupled via a communication network 139 to an international travel server 123. The communications network may be any type of communications interface such as the Internet, an intranet, or any other type of network. In another embodiment, kiosk 101 may be coupled to international travel server 123 via a wireless interconnection. The international travel server may be located at the same, or a different location, as compared to kiosk 101.

International travel server 123 is a data processing system that includes an international travel database 125. This database stores biometric data that may be used during a fast check-in and clearance process according to the current invention. This will be discussed further below.

In the illustrated embodiment, kiosk 101 also includes a biometric verification application 133. Although this application is shown to reside on kiosk 101, it may optionally reside on another server such as international travel server 123. This application, which is coupled to biometric interface 122, receives the biometric information provided by the user via one or more of biometric devices 132-138. This information may be provided during the fast check-in and clearance processes referenced above. Biometric verification application 133 compares the provided biometric information to that retrieved from international travel database 125 or that stored on a secure token to verify a user's identity.

In a preferred embodiment, biometric verification application 133 is not integrated with kiosk check-in menu application 116. By segregating the biometric verification application in this manner, updates may be made to the biometric devices 132-138 without affecting the check-in menu application. Such updates may include, for example, the addition or removal of biometric readers so that verification application 133 is processing more, or fewer, types of biometric samples. Updates may also involve modifications to the biometric verification algorithms themselves. In another embodiment, functionality incorporated within biometric verification application 133 may be integrated into one or more of the other applications residing on kiosk such as one or more of the check-in applications 116 or 142, and/or fast clearance application 143.

Kiosk 101 may include a self-test function that is executed to determine which type(s) of biometric device(s) populate the kiosk. Biometric verification application 133 may then self-configure to process the corresponding biometric readings. Alternatively, biometric verification application 133 may be configured to allow reception of any type of biometric data.

Kiosk 101 may further include kiosk airport information application 118, which provides airport-specific data unique to the location of the kiosk. This typically includes such information as the general security alert level and various operational modes specific to the location.

In one embodiment, a storage reader 124 may be provided to read temporary storage devices such as smart cards that may store information such as a user's flight preferences, frequent flyer account information, or other data that may be used to perform check-in operations. This storage reader may be adapted to read a secure token, which is a storage device such as a smart card that stores the user's biometric data. This will be discussed further below.

In one embodiment, kiosk includes an Application Program Interface (API) 126 that provides a standardized or non-standardized interface to the various internal peripheral interface devices 134 of the kiosk. These interface devices may include magnetic card readers, Automated Ticket and Boarding Pass (ATB) printers, passport scanners, and general-purpose document scanners, any of which may conform to the Common User Self Service (CUSS) standard or some other standard. API 126, which may operate in accordance with the International Air Transport Association (IATA) standard, is an interface designed to hide the specifics of the various devices from kiosk check-in application 116. That is, kiosk check-in application 116 is aware of the existence of a device, but is not required to understand the protocol needed to communicate with any particular device.

In one embodiment, biometric interface 122 is integrated into API 126 so that kiosk check-in application 116 provides all requests to one software process. In this embodiment, API 126 determines which requests are associated with biometric devices and which are associated with other interface devices.

In the exemplary system, kiosk 101 is coupled to several airline data processing systems and respective databases via kiosk server 114. The databases are shown as airline #1 database 100, airline #2 database 102, and airline #3 database 104. The respective data processing systems are shown as airline #1 host 106, airline #2 host 108, and airline #3 host 110. In the current example, each host and a respective database are associated with a different carrier. For example, airline #1 database 100 and host 106 may be associated with United Airlines, and etc. In another embodiment of the system, it may be possible for a single large-scale data processing system to support multiple airline carriers rather than having each carrier associated with a dedicated host. Additional airline hosts may also interface to the system. It is advantageous for kiosk 101 to support as many different carriers as possible, since this will allow a traveler to complete all required check-in operations for all carries using a single kiosk.

In the current embodiment, kiosk server 114 provides data processing functions needed to support some of the self-serve check-in functions of kiosk 101. Kiosk server 114 interfaces to check-in database 115, which is a database that may store flight information copied from the various proprietary databases 100-104. By storing information from a plurality of airline carriers in a consolidated format within a single check-in database, a user is allowed to perform check-in activities for all flights included within an itinerary without regard to which carrier is providing the service. This is described in detail in the commonly-assigned co-pending application entitled “Self-Service Airline Check-in System and Method That is Airline Independent”, referenced above. For purposes of the current invention, the use of kiosk server 114 and check-in database 115 is optional, and in another embodiment, kiosk 101 may interface directly to the airline hosts 106-110.

According to the current invention, kiosk 101 may be further coupled through a biometric interface 122 and communication network 139 to an enrollment system 140. In another embodiment, this enrollment system may be coupled to kiosk 101 via a dedicated, rather than a shared, interface and/or network, or may be coupled via a wireless interconnection. Enrollment system 140 supports pre-registration and authorization functions for passengers seeking to cross international borders. Passengers may use the enrollment system prior to the time of travel to register information that will allow them to utilize an automated check-in process on the day of travel. The travelers may thereby avoid the lengthy delays associated with immigration procedures conducted at the departure and destination checkpoints. Enrollment system is generally remotely located from kiosk 101. Enrollment system 140, as well as its use in conjunction with kiosk 101, will be discussed in detail in regards to the remaining figures.

According to the current invention, kiosk check-in application 116 has access to an international travel fast check-in application 142, or “fast check-in application”. This application allows a user to navigate immigration check-in procedures in an expedited manner, as will be discussed below. In another embodiment, this fast check-in application may be integrated with kiosk check-in application instead of being provided as a separate entity.

Kiosk may further include an international travel fast clearance application 143, or “fast clearance application”. This application allows a user to perform clearance activities in an expedited manner after an international border has been crossed. This application will be discussed further below.

Finally, kiosk 101 and international travel server 123 may be coupled to several automated gates 150 that control access to, and from, various restricted areas within an airport or other transportation facility. These automated gates are coupled to biometric devices 152 and/or scanners 154 to control the passage of travelers through the use of biometric data and/or scanned travel documents, respectively. This will be discussed further below in regards to the invention.

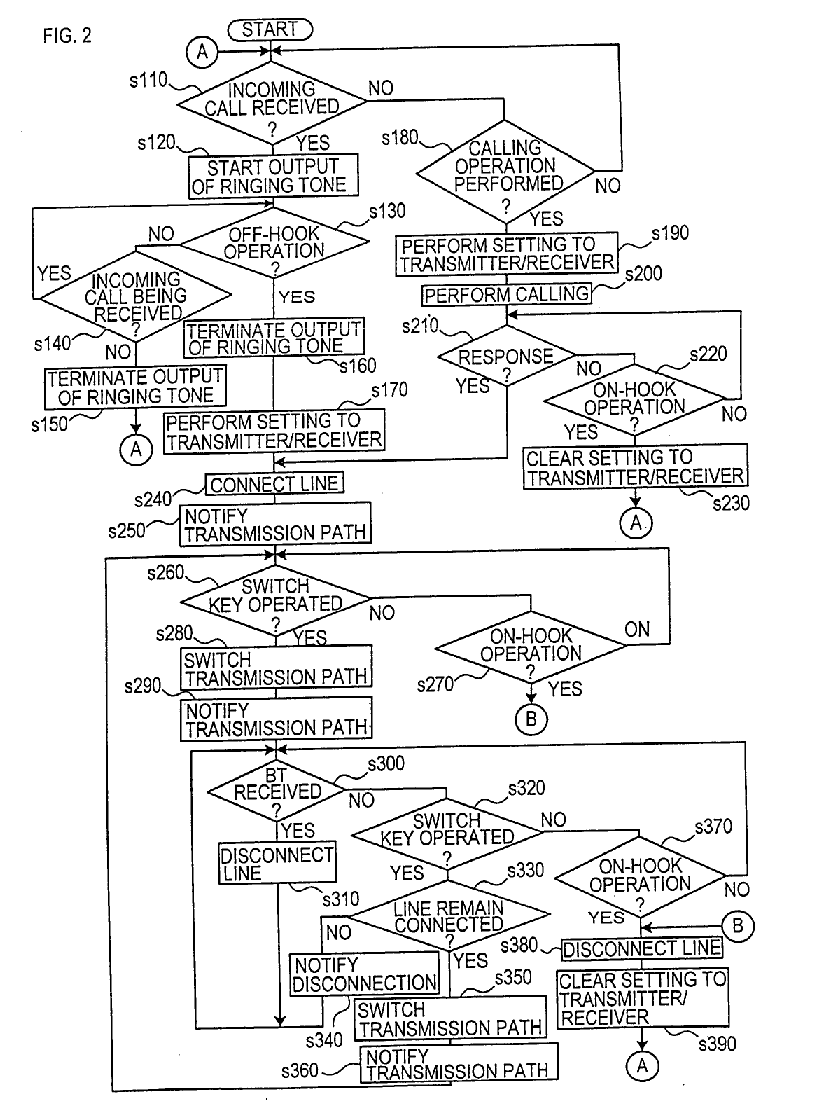

FIG. 2 is a system block diagram of one embodiment of enrollment system 140 according to the current invention. This enrollment system may be located at any convenient public location such as a shopping mall or a post office, or alternatively may be located at a private place of business. This enrollment system enrolls and pre-screens travelers that are intending to cross international borders. The enrollment process provides a convenient alternative to waiting in lengthy lines to be processed by immigration officials at the points of departure and destination.

In one embodiment, enrollment system 140 is operated by a private entity that is paid by one or more transportation carriers to pre-process customers that are planning to travel across international borders. In another embodiment, the entity that operates the enrollment system may be paid directly by travelers seeking to avoid delays on the day of travel. Instill another embodiment, a pre-enrollment system may be operated and staffed by one of the carriers themselves, or a government entity.

The exemplary enrollment system of FIG. 2 includes one or more workstations 200-202. One or more of these workstations executes an enrollment software application shown as enrollment application 213. This application allows an enrollment representative to enroll a traveler for use in an automated system that supports international travel, as will be discussed below.

The workstations may be coupled to a local network 204 such as a Local Area Network (LAN), a Wide Area Network (WAN), or any other suitable communication interface. In one embodiment, communication is accomplished via a wireless interconnection. Also coupled to local network 204 may be one or more biometric readers 206-208 to collect biometric data from users seeking to be pre-approved to cross international borders. Additional biometric readers such as biometric reader 212 may be coupled directly to one or more of the workstations 200-202. These biometric readers are employed to obtain finger print scans, iris scans, voice prints, facial scans, handwriting samples, and/or any other type of biometric data that may be used for identification purposes. The collection and use of this data will be discussed further below.

Local network 204 may further be in communication with a passport scanner 210. As is known in the art, passport scanners are high quality, full-page color scanners that are employed to scan and interpret passport documents. Additional passport scanners such as passport scanner 214 may be coupled directly to one or more of workstations 200-202. If desired, one or more general-purpose scanners such as document scanner 216 may also be included in the system to scan other documents such as a birth certificate, driver's license, or another Official Travel Documents (OTD). As discussed above, an OTD is an official document issued by a state or organization that is used by the holder for international travel.

Finally, local network 204 may interface to one or more secure token writers 218. These devices are adapted to store biometric data that is collected from users on secure tokens that may comprise smart cards or other portable storage devices. Biometric data is generally stored on a secure token in an encrypted, secure format that can only be read by a device that utilizes an appropriate encryption key. Additional secure token writers such as secure token writer 220 may interface directly to one or more of workstations 200-202. The use of secure tokens is discussed further below.

As discussed above, enrollment system 140 may be coupled to remotely located kiosk 101 via communications network 139, via a wireless interconnection, or in any other manner known in the art.

It will be understood that the system of FIG. 2 is merely exemplary. Enrollment system 140 could be configured in many other ways. For example, the system could comprise a central server that that is coupled to communications network 139, the one or more biometric readers 206-208, the secure token writers 220 and 218, the passport scanners 210 and 214, and one or more input devices and/or terminals. This central server may support enrollment functions. Alternatively, all of the devices of FIG. 2 may communicate via wireless means. Other embodiments are possible within the scope of the current invention.

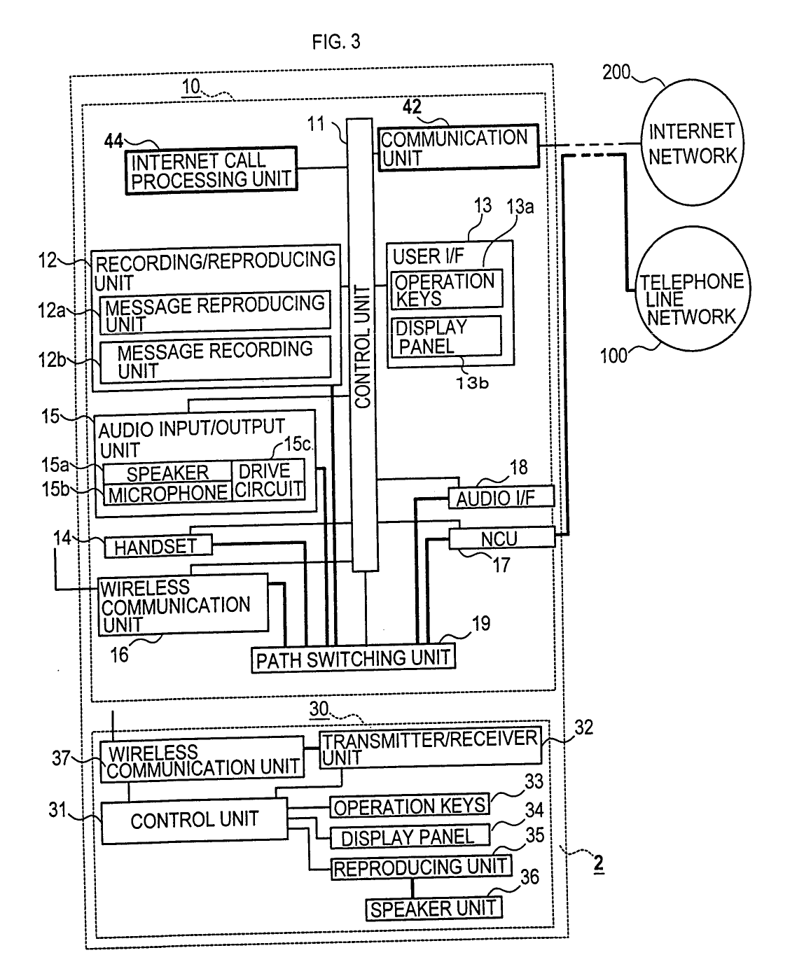

As discussed above, the system of FIG. 2 is used to pre-approve a traveler for an international border crossing. The enrollment process will take place some time prior to the time the traveler is embarking on the journey. This process is discussed in detail in reference to FIG. 3.

FIG. 3 is a flow diagram of one embodiment of an enrollment process according to the current invention. First, in one embodiment, a traveler subscribes to the pre-enrollment service (300). This may involve signing onto a website and completing a subscription form with a fee, or merely appearing at an enrollment station. In another embodiment, a user may qualify for the enrollment process by purchasing an international ticket from a carrier that subscribes to the enrollment process.

Next, sometime prior to the time of the trip, the traveler presents himself at the enrollment station to undergo the enrollment process (302). An enrollment representative manually verifies the traveler's identification (304). This may be accomplished by comparing the user's passport or driver's license photograph to the user, and optionally, by obtaining a signature. Then, one or more of the traveler's documents are scanned (306). For example, in one embodiment, the user's passport is scanned using one of passport scanners 210 or 214. If desired, other documents such as an OTD or a driver's license could be scanned in addition to, or instead of, using general-purpose document scanner 216.

After the one or more documents are scanned, selected portions of the scanned data are electronically transferred to a predetermined enrollment official. This official may be a national immigration office or the state department (308). The transferred data is then used to retrieve a digital photograph for the user that is on file with the enrollment official (310). For example, in the United States, a digital passport photograph may be retrieved from the U.S. State Department. The digital photograph is then transferred to the enrollment representative at the enrollment station.

After the enrollment representative receives the digital photograph, the representative again verifies the identity of the traveler (312). This can be accomplished by comparing the photograph that was on file both with the appearance of the traveler, and the photograph that was presented on the traveler's documents. In the embodiment wherein both photographs are current passport photographs, the two images should be identical. The traveler may be required to produce additional identification information such as an official copy of a birth certificate, or a social security card, for instance. If the verification process fails because a favorable comparison is not obtained, local procedures for the handling of suspected fraudulent documents are followed (314).

If the identification verification completes successfully, biometric data is collected from the traveler using biometric readers 206-208, and 212. This collected data may include finger print scans, iris data, voice prints, facial scans, handwriting samples, and/or any other type of biometric data that may be used for identity verification purposes. In a preferred embodiment, multiple biometric readings, including a facial scan and fingerprints of both index fingers, are obtained. By obtaining multiple readings, a more accurate identification of the user can be performed. Optionally, additional information may be collected from the traveler for storage into the system (316). The digital image of the document(s), the biometric data, and any other collected information is transferred to international travel server 123 to be stored in a record that is created for the traveler within international travel database 125 (318).

In one embodiment, collected biometric data may be stored on a secure token instead of, or in addition to, storing this data in the international travel database. As discussed above, this storage operation is completed using a secure token writer, which employs an encryption mechanism to create a secure record of the user's biometric data on a portable storage device such as a smart card. Any other portable storage device may be employed in the alternative. This secure token is provided to the user, who may use the encoded biometric data to complete identification verification on the day of travel.

Sometime before, during, or after, the collection of biometric data, various manual and/or automated checks are initiated to assess whether the traveler poses any known criminal, terrorist, immigration, health, or other concerns to the country or countries that are being entered (320). For example, national and international law enforcement databases may be searched to determine whether the person has been involved with an unpardoned offense, is suspected of terrorist activities, or is associated with immigration violations. If travel to the United States is contemplated, databases maintained by the U.S. Federal Bureau of Investigation (FBI), the U.S. Department of Homeland Security, and/or local law enforcement or other agencies may be searched. The databases that are searched are selected based on the country or countries to be entered. The searches may be automatically initiated via the Internet, for example. Manual processing and checks may also be initiated by various governmental or other agencies. The results of the searches and various risk assessments are entered into the traveler's enrollment record stored within international travel database 125.

Sometime after the enrollment process of FIG. 3 has been completed, the date of travel arrives. In the current embodiment, the traveler arrives at an airport terminal in preparation for departure. Of course, in another embodiment, the current system and method could likewise be employed at a bus or train terminal, or any other transportation facility supporting international travel. The traveler approaches some type of user interaction device such as self-service kiosk 101 of FIG. 1 to initiate a self check-in procedure.

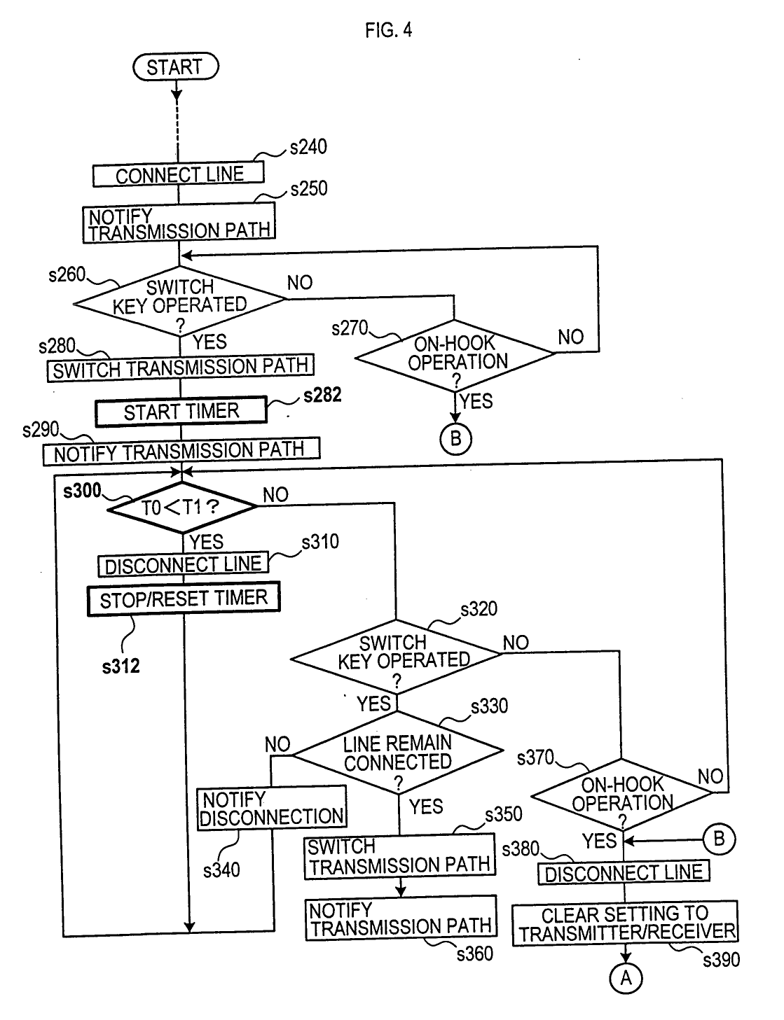

FIG. 4 is a flow diagram illustrating one method of performing self check-in according to the current invention. The traveler approaches a self-service kiosk such as exemplary kiosk 101. Employing one or more of the user interface devices 112 such as a touch screen, a user selects an international check-in menu from the main menu (400). This selection causes kiosk check-in application 116 to evoke functionality provided by fast check-in application 142. In another embodiment, the functionality provided by fast check-in application 142 may be included within kiosk check-in application 116.

Using the fast check-in application menu, the user is prompted via textual and/or audible instructions to enter identification information. For example, the user may be prompted to enter a pin number, name, social security number, the user's frequent flyer number, credit card number, and/or any other user indicia that provide unique identification. This information may be entered using a keypad provided by user interface devices 112. Alternatively, the kiosk may include a magnetic swipe reader for entry of the frequent flyer or credit card number.

In one embodiment, the user is instead prompted to scan one or more travel documents utilizing a scanner, which in the current embodiment, is included as one of interface devices 134 (404). For example, the traveler's passport may be scanned using a passport scanner. Other travel documents may also be required instead of, or in addition to, a passport, such as an OTD.

Next, fast check-in application 142 initiates a request to biometric interface 122, which, in turn, references international travel server 123. Personal information provided during step 400 and/or information extracted from the document image(s) scanned in step 404 is employed to attempt to retrieve the traveler's enrollment data from international travel database 125. If located, this data is returned via communication network 139 and biometric interface 122 to fast check-in application 142.

Next, it is determined whether the traveler is eligible to use the automated check-in process (406). This will be accomplished by verifying that the biometric enrollment procedure has been completed. This further involves obtaining the status stored within the enrollment record to determine whether the traveler passed all required threat assessment background checks. As discussed above, these checks may be initiated and performed automatically and/or manually as part of the enrollment procedure.

In one embodiment, step 406 may also include verification of the traveler's documents. For example, these documents may be compared against images stored within international travel database 125 or another database. This may further involve verifying that the scanned travels documents have not expired.

If it is determined that the traveler is eligible to continue, fast check-in application 142 initiates a request to kiosk server 114 to retrieve the traveler's itinerary from check-in database 115. In another embodiment, this request is issued directly to one of the airline hosts 106-110. The user may be queried as to whether the correct itinerary has been retrieved. When the user indicates the correct itinerary has been retrieved, fast check-in application 142 determines whether that itinerary is valid for use of the automated system (408). Because of travel alerts, high security threat levels, or other changing world conditions, travel across certain international borders may be prohibited without undergoing a manual security and immigration check. In this case, certain itineraries may disqualify a user from employing the automated process. Because the conditions that dictate which itineraries may be disqualified are always changing, the information concerning these restrictions may be conveniently retained by kiosk airport information application 118. For example, this information may be downloaded on a regular basis along with other terminal-specific information as world conditions dictate.

If a traveler's itinerary is valid for use with the automated system (408), the traveler is provided with textual and/or audible directions concerning how to provide one or more biometric readings. In response to these directions, the user provides the biometric data via biometric devices 132-138, which may include any type of biometric device, as discussed above (410). In the current embodiment, a facial scan and fingerprints are used to verify identity. Any other biometric data may be used instead, or in addition to, these readings.

Next, the collected biometric data is compared to data retrieved during the enrollment process (412). In one embodiment, biometric verification application 133 compares the collected data to the data that was retrieved from international travel database 125 along with the traveler's enrollment data. Match indicia are generated based on this comparison. If one or multiple biometric readings collected from the traveler cannot be located within the traveler's enrollment record, the unmatched reading(s) may be discarded. Alternatively, all collected user readings such as the facial scan and fingerprints could be considered mandatory such that identity verification fails if corresponding data readings are missing from the biometric database stored within international travel server 123. The action taken in this case could be selectable based on local or countrywide security levels in place at the time. For example, if a particular region is on high alert for possible terrorist threats, the number of required biometric readings that must match before identity is confirmed may be increased.

In one embodiment of the invention, biometric verification application 133 generates a comparison score that indicates the extent to which the collected data matches the enrollment data. If the score exceeds a predetermined minimum score (414), a match indication is provided to fast check-in application 142. Otherwise, a “verification failed” indication is provided to fast check-in application 142, and is further stored with the traveler's enrollment record stored in international travel database 125.

In still another embodiment, the biometric verification described above could be performed on the international travel server 123. In this embodiment, the biometric data collected by fast check-in application is transferred to the international travel server so this verification can be completed by a biometric verification application resident on this server. The results of the comparison are then transferred back to kiosk 101.

In yet another embodiment, step 412 is performed by comparing the biometric data collected from the user during the check-in process to data stored on a secure token carried by the user. As discussed above, secure tokens may comprise smart cards or other portable storage devices. Biometric data is generally stored on a secure token in an encrypted, secure format that can only be read by a device that utilizes an appropriate encryption key. Such tokens may be created during the enrollment process using a secure token writer. In this embodiment, the traveler is directed to provide the token to a token reader such as storage reader 124. Biometric data read from the secure token is then used by biometric verification application 133 to perform identification verification in any of the ways discussed above.

In the instant case, it will be assumed that a match has occurred such that the traveler has been positively identified. The traveler is therefore prompted to complete electronic customs declarations forms and any other questionnaires that are required by the destination country (416). In one embodiment, these forms can be downloaded from international travel database 123 each time they are to be completed to ensure that each traveler always completes the most current revision of that document. Alternatively, the forms can be downloaded from international travel server 123 to kiosk 101 at predetermined time increments, or only when the international travel server indicates an update has been made to the form.

Finally, a boarding pass and any additional documents such as baggage tags and claim forms are printed by ATB and bag tag printers (418).

If, in step 406, the travel is determined to be ineligible to use the automated check-in process, if the traveler's itinerary does not permit automated processing (408), or if the traveler's identity is not verified (414), a rejection code is entered in the traveler's record within international travel database 125 (420). This code will indicate the type of problem that was encountered. Further, a report may be generated and printed indicating the reason for rejection. The traveler will then be directed to the appropriate manual screening process that is conducted by an appropriate agency based on the reason for the rejection (422). The traveler may also be directed to undergo manual screening as the result of being selected during a random selection process that applies to all travelers, including those eligible to use the automated check-in process.

After the international check-in process is completed, the user may use other menus provided by kiosk check-in application 116 to view and/or modify flight information. For example, the user may select another menu provided by kiosk check-in application 116 that will allow viewing or modification of flight information. Assuming the user wished to view flight information, a request will be forwarded by kiosk check-in application 116 to kiosk server 114. Kiosk server 114 may retrieve the requested information from one of the host databases 100-104 directly. Alternatively, in an embodiment that includes check-in database 115, the requested information may instead be obtained from check-in database, which caches flight data from all carriers. This latter approach allows flight information from all carriers to be retrieved in a more efficient manner, since independent hosts need not be referenced. This is discussed further in the application entitled “Self-Service Airline Check In System and Method That is Airline Independent” referenced above.

Regardless of how the information is retrieved, it will be returned to kiosk check-in application 116 for presentation to the traveler. The traveler may review, and if necessary, update any flight information and/or book additional flights. Any international flights will require the user to follow the procedures described herein.

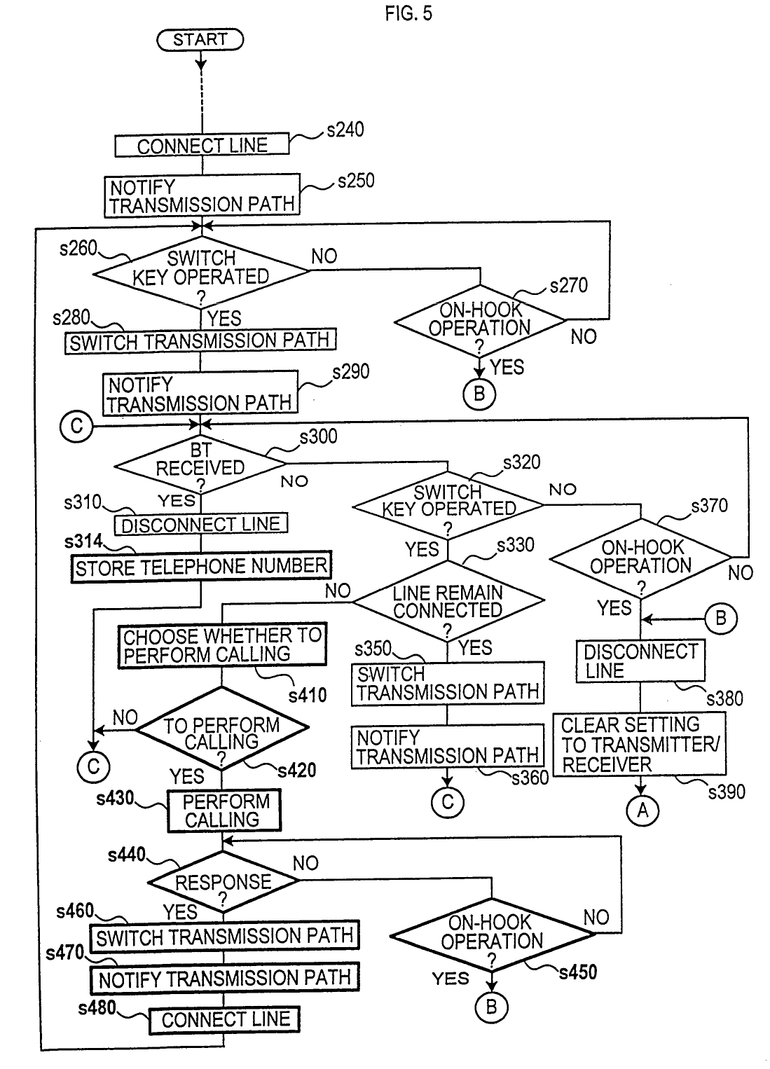

Following the completion of the automated check-in process, the user is allowed to board the airplane. While the user is enroute to the destination, the data collected by the kiosk, including the answers presented on any declaration forms, is transferred to international travel server 123 and/or another server to be processed in a manner described in reference to FIG. 5.

FIG. 5 is a flow diagram illustrating one embodiment of a method for handling and utilizing data collected during the automated check-in process. As discussed above, selected data collected during the check-in procedure, including the electronic declaration form and any additional questionnaires, is transferred to the international travel server 123 and/or another server associated with a government agency or another organization (500). This information will further describe the various goods being carried with the traveler.

In one embodiment, in addition to routing the traveler's data to the international travel server, the data is further routed to one or more government agencies such as the U.S. State Department, a immigration department, or another organization for manual and/or automated checks. Alternatively, personnel from the government agency or another organization may access the data on the international travel server 123. The government agency or the other organization may review the answers to the declaration and the other questionnaires along with any other transferred data to determine whether the traveler is required to undergo manual processing upon arrival at the destination (502). Additionally, or in the alternative, the data may undergo automated checks performed by software. These manual and/or automated checks may include a review of the value or type of goods listed on the declaration form. If these goods are determined to pose a health, agricultural, or other type of threat, the traveler must undergo a manual screen process at the destination. The traveler might further be disqualified from automated processing because of recent travel to countries or locations determined to pose health risks.

In one embodiment, the traveler's identity may be checked against various databases to verify that the person's status has not changed since the time of enrollment (504). For example, national and international law enforcement databases may again be searched to re-verify that the person has not been involved with an unpardoned offense, is not suspected of terrorist activities, and is not associated with immigration violations. The databases that are searched may be selected based on the country or countries to be entered. The searches maybe automatically initiated by international travel server 123 via the Internet, for example.

Finally, in one embodiment, if the traveler is a first-time user of the automated system, the traveler is disqualified from using the automated system upon arrival at the destination (506). Instead, the traveler is required to undergo a manual interview process with a immigrations official after the traveler disembarks at the destination. If this interview does not result in disqualifying the user from using the automated process in the future, the immigrations official will enter a permission code in the traveler's data stored in international travel database 125. This code will enable the user to complete automated processing during any subsequent border crossing, except in those situations wherein the user is randomly selected to undergo manual processing. As noted above, even travelers that are eligible to use the automated check-in and clearance processes are subject to possible manual screening as the result of a random selection procedures.

If the travel is ineligible for automated processing, if the traveler is randomly selected for manual screening, or if database searches uncover a potential problem, a rejection code is entered in international travel database 125 with the traveler's data. This code will indicate the type of problem or circumstance encountered. For example, the code may identify a particular section of a questionnaire that disqualified the traveler for automated processing, or may be a code indicating the traveler is disqualified as a first-time user of the system. Alternatively, the code may indicate the type of potential problem uncovered by the database search. On the other hand, if processing completes successfully, an acceptance code is recorded, indicating that automated processing is permissible (508).

The foregoing describes an embodiment wherein the international travel server 123 performs processing that is needed to allow the traveler to continue with the automated process at the point of destination. It will be understood that some, or all, of this processing could likewise be performed by one or more of the applications residing on kiosk 101. For example, kiosk 101 could initiate the searches required to determine whether the traveler poses any threat to the country that is being entered.

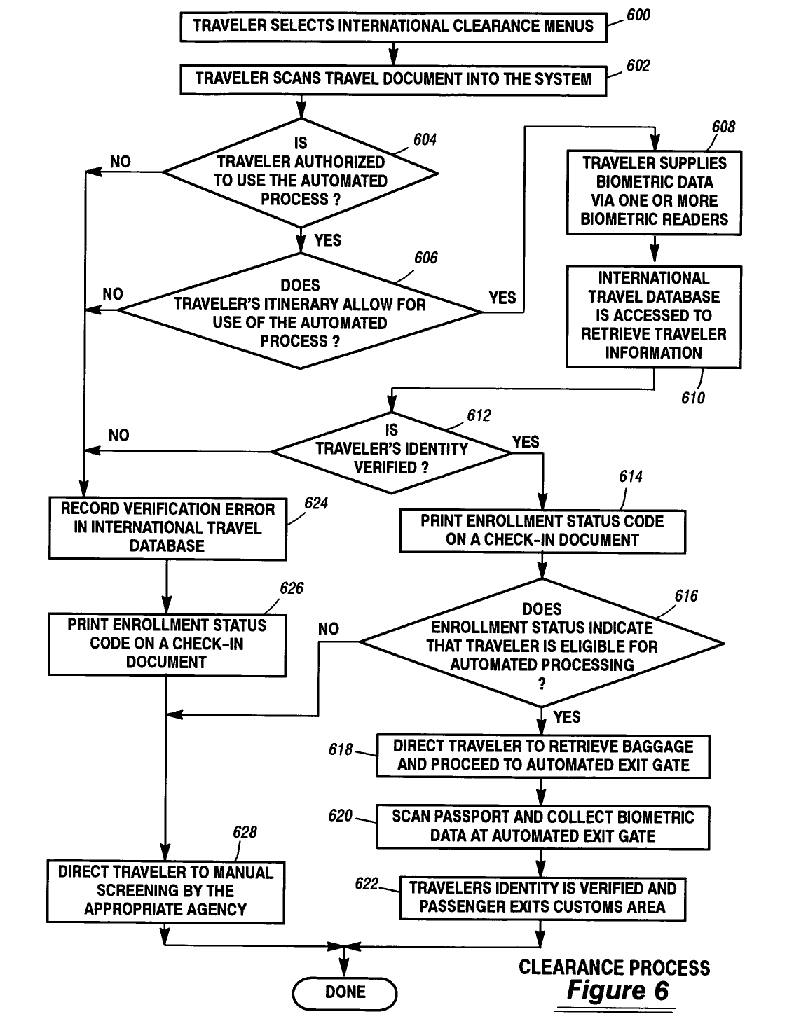

The next portion of the automated process is conducted when the traveler arrives at the destination after the international border crossing has been completed. At this time, the traveler must undergo a clearance process using the fast clearance application 143. This is discussed below in reference to FIG. 6.

FIG. 6 is a flow diagram illustrating one embodiment of a clearance process according to the current invention. Upon arrival at a destination terminal, the traveler approaches a user interaction device such as self-service kiosk 101 illustrated in FIG. 1. Employing user interface devices 112, the traveler selects the international clearance menu, which in the embodiment shown in FIG. 1, is generated by fast clearance application 143 (600). The menu prompts the traveler to scan a travel document such as a passport or OTD into the system (602). Fast clearance application 143 then determines whether the traveler used the fast check-in application 142 prior to travel departure, and, in one embodiment, whether the traveler is other than a first-time user of the system (604). If so, the traveler is an enrolled participant authorized to utilize the fast clearance process. If the traveler is not an enrolled participant, the traveler must undergo the more lengthy clearance process involving human intervention.

Next, it is determined whether the traveler's itinerary allows for use of the automated process (606). For example, in some cases, a traveler arriving from a country that has been determined to pose a security or health risk may be ineligible for processing using the automated process. If the traveler is eligible for automated processing, the traveler is prompted to supply biometric data via one or more of the biometric devices 132-138 (608). In the current example, a facial scan and fingerprints are collected, although other biometric readings could be used in addition to, or instead of, these readings. Biometric interface 122 retrieves previously collected biometric samples from international travel database 125 so that these samples may be compared to the newly collected biometric data by biometric verification application 133. Alternatively, this comparison may be performed by a biometric verification application residing on international travel server 123. As described above, in an alternative embodiment, this verification process is performed by comparing the collected biometric data to biometric data stored on a secure token instead of data retrieved from international travel database 125.

If identification verification completes successfully (612), the status code obtained from the traveler's enrollment record is printed on a check-in document (614). Recall that this status code was generated after the check-in data has been processed in the manner discussed in reference to FIG. 5. In one embodiment, the check-in code is printed on a color-coded stock card for inspection by a immigration agent. For example, a green card may indicate the traveler may proceed, wherein a red card denotes that the traveler must be detained for manual processing.

Next, if the enrollment status code indicates the traveler may continue with the automated process (616), the traveler is directed to retrieve baggage and proceed to an automated exit gate such as one of gates 150 of FIG. 1 (618). At this gate, the traveler is directed to scan one or more travel documents such as a passport (620). Further, the traveler may again be directed to provide biometric data via one or more biometric readers. Data collected at the gate is transferred via communication network 139 to international travel server 123, which compares the collected data to the data stored within the traveler's enrollment record. If the verification completes successfully, the gate is opened to allow the traveler to exit the immigration area (622). Any attempt to pass through the gate in an unauthorized manner, as may occur by someone passing through the gate after it is opened for another traveler, is detected by a sensor that sounds an alarm.

If any of the checks performed during steps 604, 606, or 612 fails, an error is recorded in the international travel database (624). This status code may be printed on a document in a manner similar to that discussed above in regards to step 614 (624). The traveler is then directed to a manual screening process that is performed by an appropriate agency, as determined by the type of error that occurred (628). A manual screening process is also required for those passengers that were associated with enrollment status that indicated a problem in step 616.

The foregoing embodiment assumes that all of the checks that are performed to determine whether the traveler is eligible to undergo the automated clearance process are initiated and/or performed by either the kiosk used during check-in, or the international travel server. This need not necessarily be the case. For example, a kiosk at the destination location that is used to initiate the clearance process could also initiate these verifications, which include reviewing information provided on the declaration form(s), and initiating searches of various databases to determine whether the traveler poses any threat to the destination country. However, since completion of these checks may cause a delay in the clearance process, it is preferable that these checks be initiated and completed while the traveler is enroute to the destination by international travel server 123 or the check-in kiosk.

Having thus described the preferred embodiments of the present invention, those of skill in the art will be readily able to adapt the teachings found herein to yet other embodiments. For example, although the current system and method were described primarily in regards to airline travel, any other form of transportation requiring international border crossings may likewise utilize the current invention. Therefore, the scope of the invention is not to be limited by the exemplary embodiments, but rather by the claims that follow.

What is claimed is:

1. A method for processing travelers crossing international borders, comprising:
a.) prior to the time of travel, enrolling a traveler to utilize an automated check-in process; and
b.) at the time of travel, utilizing an automated check-in process to complete activities necessary to enable an international border crossing.

2. The method of claim 1, wherein step a.) includes:
obtaining an image of a travel document; and
comparing the image to an image on file with an enrollment official.

3. The method of claim 2, wherein
the obtaining step includes scanning the travel document to obtain a digital image; and
the comparing step includes comparing the digital image to a digital image on file with the enrollment official.

4. The method of claim 3, wherein the travel document is selected from the group consisting of passports and Official Travel Documents (OTDs).

5. The method of claim 2, wherein step a.) includes collecting unique identification indicia from the traveler for use in performing identification verification on the day of travel.

6. The method of claim 5, wherein the identification indicia includes biometric data.

7. The method of claim 6, wherein the biometric data is selected from a group consisting of handwriting samples, iris scans, hand or finger geometry, facial scans, facial geometry measurements, hand scans, fingerprint samples, physical measurements, and voice samples.

8. The method of claim 5, wherein the biometric data includes at least two different types of biometric samples.

9. The method of claim 5, and further including storing the identification indicia for use during the automated check-in process.

10. The method of claim 9, wherein step b.) includes
retrieving the record;
collecting unique identification indicia from the traveler; and
automatically comparing the collected identification indicia to the stored identification indicia to verify identity of the traveler.

11. The method of claim 10, wherein the retrieving step includes:
scanning a travel document; and
using information on the travel document to retrieve the stored identification indicia.

12. The method of claim 10, and further including automatically verifying that the traveler's itinerary qualifies the user to use the automated check-in process.

13. The method of claim 10, and further including automatically prompting the traveler to electronically complete at least one questionnaire required for the international border crossing.

14. The method of claim 13, and further including checking the at least one completed questionnaire to determine whether the traveler is eligible to utilize an automated clearance process after the international border has been crossed.

15. The method of claim 10, and further including automatically printing documents to allow the traveler to embark on the international border crossing.

16. The method of claim 1, wherein the automated check-in process is performed on a self-service kiosk.

17. The method of claim 1, and including performing one or more automated checks to determine whether the traveler poses any risk to the country of destination.

18. The method of claim 17, wherein the checks are selected from the group consisting of a criminal check, a terrorist check, an agricultural check, and an immigration check.

19. The method of claim 17, and further including, after the international border crossing has been completed, utilizing an automated clearance process to allow the traveler to enter a country.

20. The method of claim 19, wherein the automated clearance process includes:
verifying the identity of the traveler;
obtaining results of the one or more automated checks;
if any of the automated checks failed, requiring the traveler to undergo a manual clearance process; and
if all of the automated checks passed, allowing the user to enter the country of destination without undergoing the manual clearance process.

21. The method of claim 20, and further including enabling an automated exit gate to allow a user to enter the country of destination.

22. The method of claim 10, wherein the storing step includes creating a secure token storing the identification indicia.

23. A system for performing automated processing of a traveler crossing an international border, comprising:
a data processing system to enroll a traveler to use an automated check-in procedure; and
a first user interaction system coupled to the data processing to provide the automated check-in procedure that automatically initiates activities necessary to allow the traveler to cross the international border.

24. The system of claim 23, and further including a second user interaction system coupled to the data processing system to provide an automated clearance procedure that automatically initiates activities necessary to allow the traveler to enter a country of destination after the international border has been crossed.

25. The system of claim 24, wherein at least one of the first and the second user interaction systems are self-service kiosks.

26. The system of claim 24, wherein at least one of the first and the second user interaction systems includes at least one biometric reader to read biometric samples from the traveler.

27. The system of claim 24, wherein at least one of the first and the second user interaction systems includes a scanner to scan travel documents.

28. The system of claim 24, wherein the first user interaction system obtains data from the traveler that is required to allow entry into the country of destination.

29. The system of claim 28, wherein at least one of the data processing system and the first user interaction system includes means for checking the data to determine whether the traveler is allowed to utilize the second user interaction system to complete the automated clearance procedure.

30. The system of claim 29, wherein at least one of the data processing system and the first and second user interaction systems includes means to initiate automated checks to determine whether the traveler poses any threat to the country of destination.

31. A system for managing the crossing of an international border by a traveler, comprising:
enrollment means for enrolling the traveler in an automated travel process; and
automated user interface means for allowing the user to participate in the automated travel process that completes all activities required for entry into a country without the need for human intervention.

32. The system of claim 31, wherein the automated user interface means includes:
first means for automatically performing check-in activities before crossing the border; and
second means for automatically performing clearance activities after crossing the border.
